(19) United States
(12) Patent Application Publication
(10) Pub. No.: US 2008/0098123 A1
(43) Pub. Date: Apr. 24, 2008

(54) Hybrid Peer-to-Peer Streaming with Server Assistance

(75) Inventors: Cheng Huang, Redmond, WA (US); Philip A. Chou, Bellevue, WA (US); Jin Li, Sammamish, WA (US); Anders E. Klemets, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/552,374

(22) Filed: Oct. 24, 2006

(51) Int. Cl. G06F 15/16

(52) U.S. Cl. 709/231

(57) ABSTRACT

Implementation of hybrid peer-to-peer streaming with server assistance is described. In one implementation, a media source is selected from amongst a plurality of media sources for retrieval of streaming media content. The selection might be based, for example, on an amount of the streaming media content received at respective time units. In one scenario, if the amount received at a time unit is less than a target amount, the streaming media content is retrieved from at least one streaming media server. Conversely, if the amount received at a time unit is more than the target amount, the streaming media content is retrieved from at least one peer-to-peer network. In another embodiment, a playback buffer is monitored to determine an amount of streaming media content at the respective time units. The media source is then selected based on the amount of the streaming media content in the playback buffer.

### BACKGROUND

Streaming media technology enables real-time or on-demand access to audio, video and multimedia content via a network. Streaming over networks has become a reality with the development of efficient media compression methods, high throughput storage systems, and broadband networking technology. Attractive applications built on top of real-time media streaming service (e.g., entertainment video-on demand, digital library, and on-line news service) are also available. However, there are still many challenges towards building cost-effective, robust and scalable multimedia streaming systems.

Various system architectures are currently used to provide streaming media solutions. In a client-server system, distribution of content is managed centrally. The content files reside on a centrally organized server system and the client connects directly with the server to download a file. On the other hand, a Peer-to-Peer (P2P) network offers a decentralized network of peer computers. The peer computers form an overlay network and share resources such as content files, storage, processing capacity, and bandwidth. In comparison, Content Distribution Network (CDN) systems are mid-way between a client-server system and a P2P network. A CDN replicates the content from the place of origin to replica servers or proxies that are scattered over the network. A request from a client to a CDN is served from a replica server or proxy close to where the request originated rather than from a central server.

### SUMMARY

Implementation of hybrid peer-to-peer streaming with server assistance is described. In one implementation, in a streaming session, a media source is selected from amongst a plurality of media sources for retrieval of streaming media content. The selection might be based, for example, on an amount of the streaming media content received at respective time units. In one scenario, if the amount received at a time unit is less than a target amount, the streaming media content is retrieved from at least one streaming media server. Conversely, if the amount received at a time unit is more than the target amount, the streaming media content is retrieved from at least one peer-to-peer network. In another embodiment, a playback buffer is monitored to determine an amount of streaming media content at the respective time units. The media source is then selected based on the amount of the streaming media content in the playback buffer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

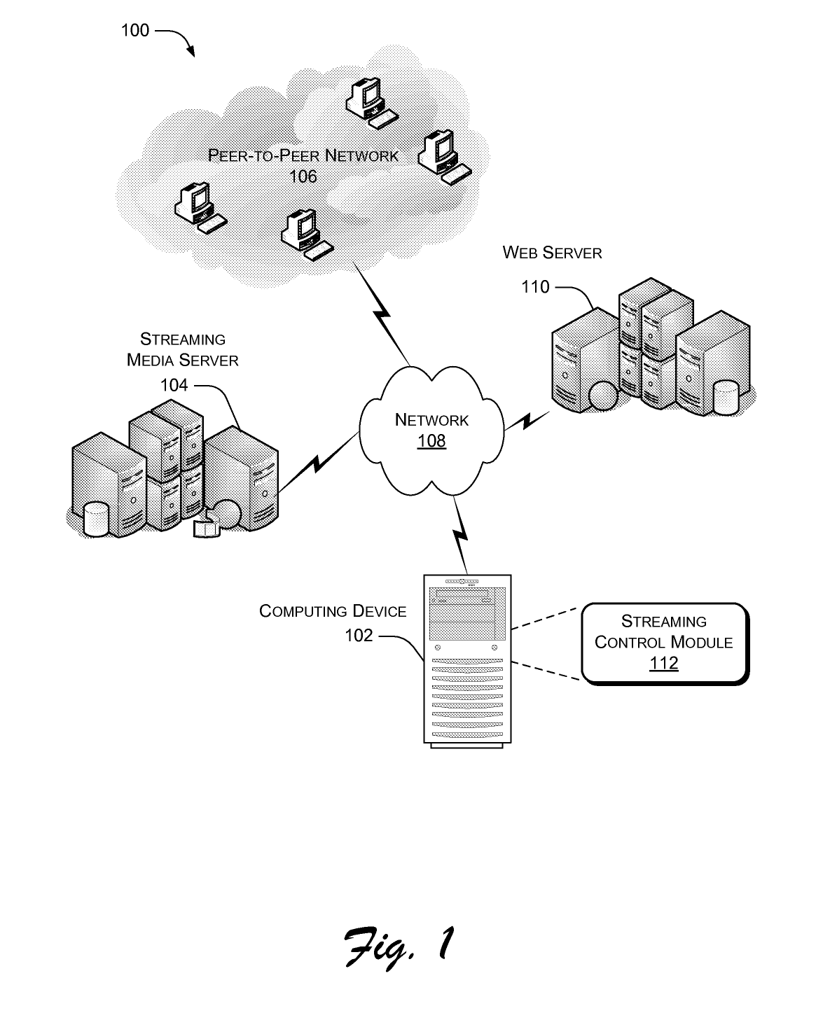

FIG. 1 illustrates an exemplary environment in which hybrid peer-to-peer streaming with server assistance may be implemented.

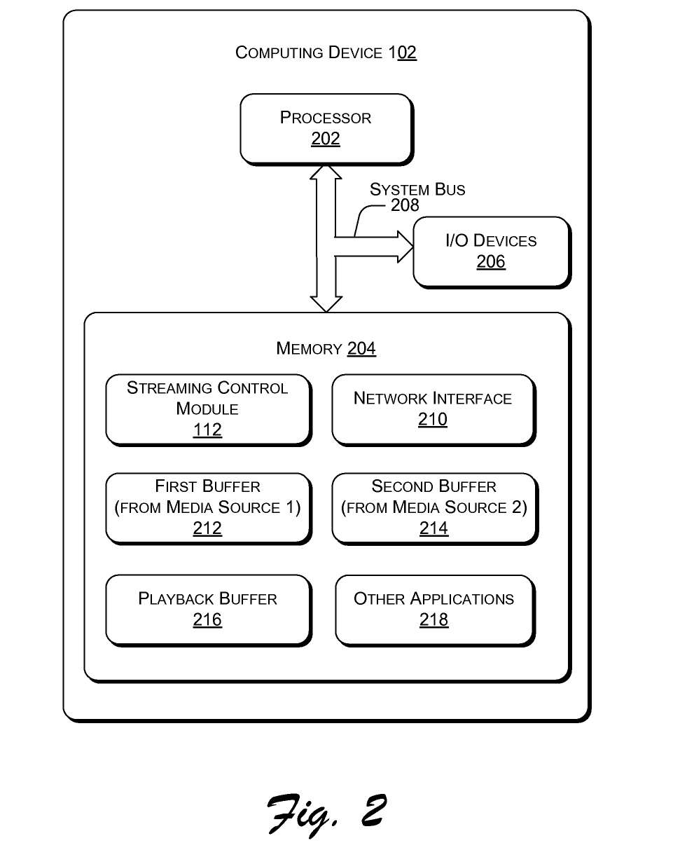

FIG. 2 is a block diagram illustrating an exemplary computing device for implementing hybrid streaming.

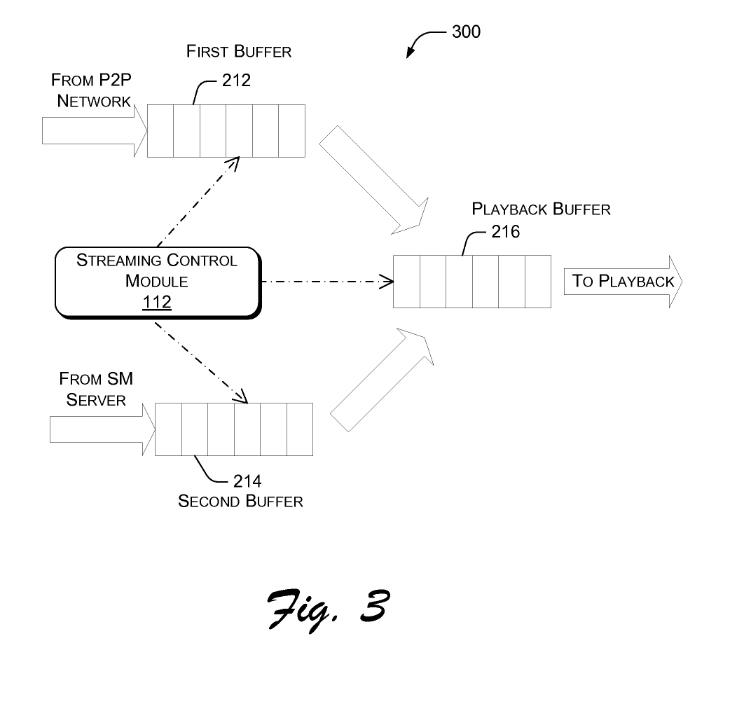

FIG. 3 illustrates data flow in hybrid streaming in an exemplary implementation.

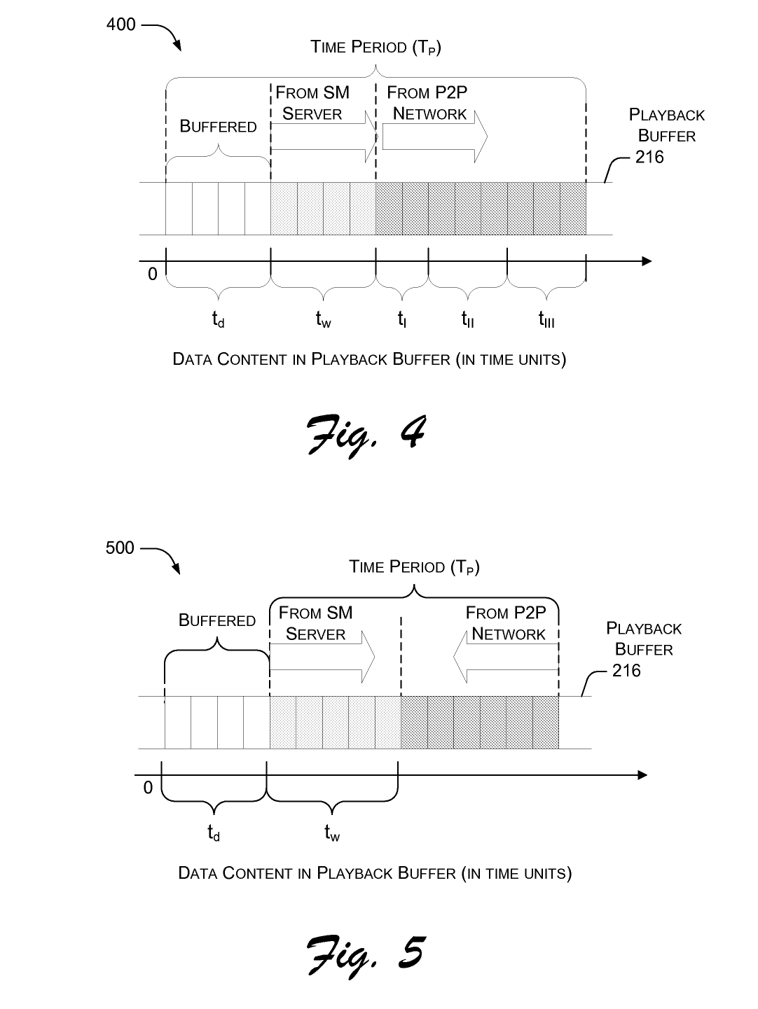

FIG. 4 illustrates one exemplary approach to filling up a playback buffer with streaming media from different sources.

FIG. 5 illustrates another exemplary approach to filling up a playback buffer with streaming media from different sources.

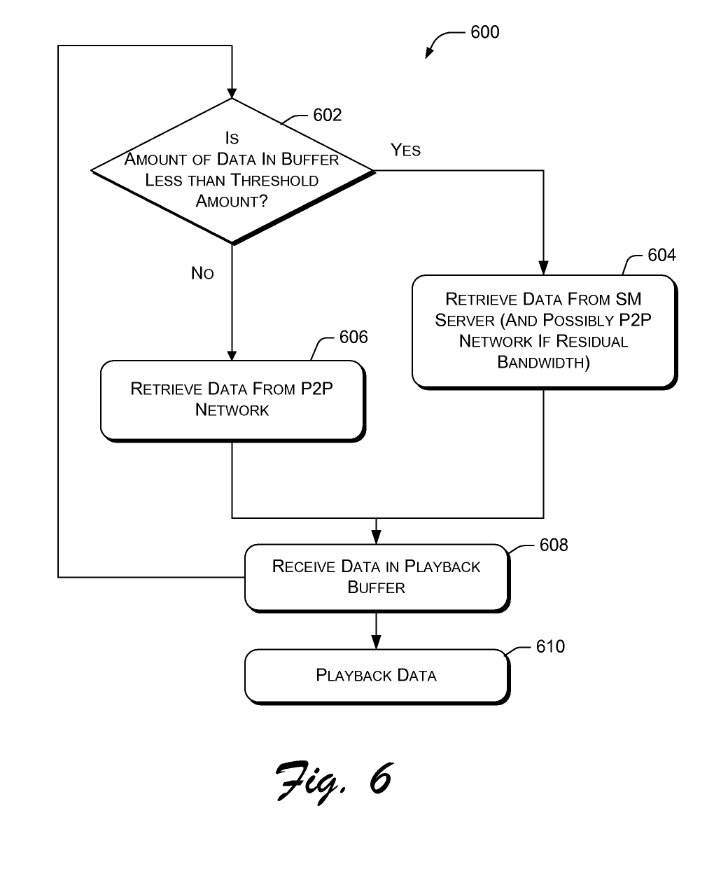

FIG. 6 is a flow diagram illustrating an exemplary process for hybrid streaming.

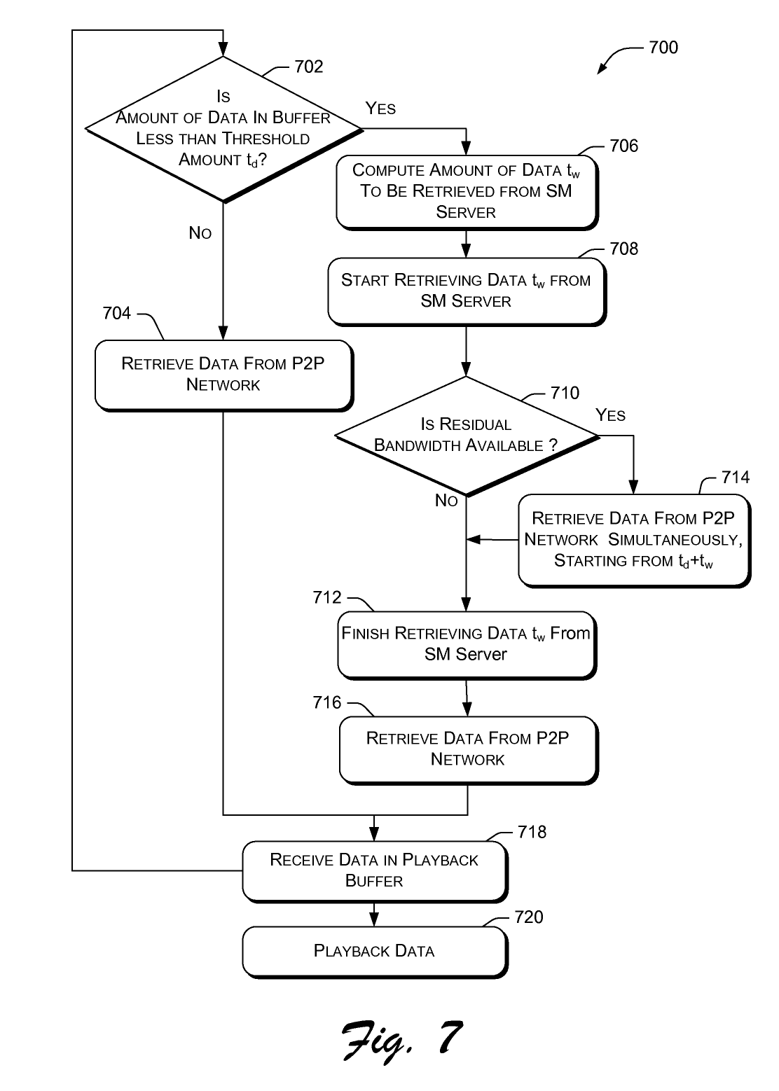

FIG. 7 is a flow diagram illustrating an exemplary process for filling up a playback buffer with streaming media from different sources, where the buffer is filled in the same temporal direction.

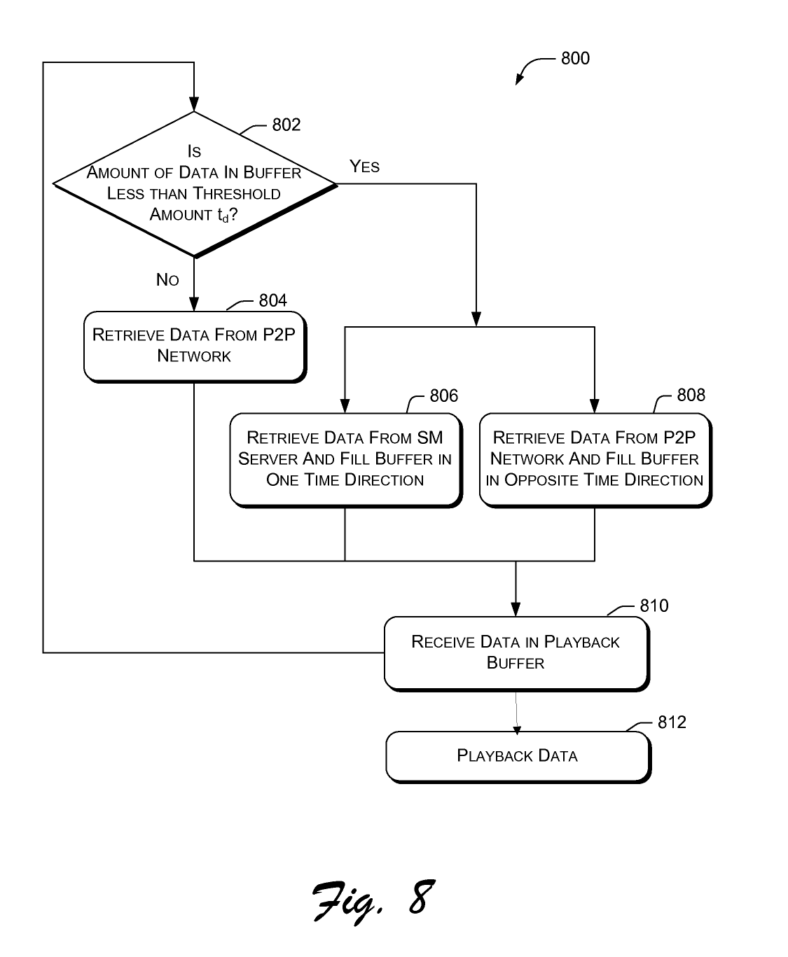

FIG. 8 is a flow diagram illustrating another exemplary process for filling up of a playback buffer with streaming media from different sources, where the buffer is filled in different temporal directions.

FIG. 9 shows a comparison between an optimal policy and a simulation of hybrid streaming according to one approach of filling up a playback buffer

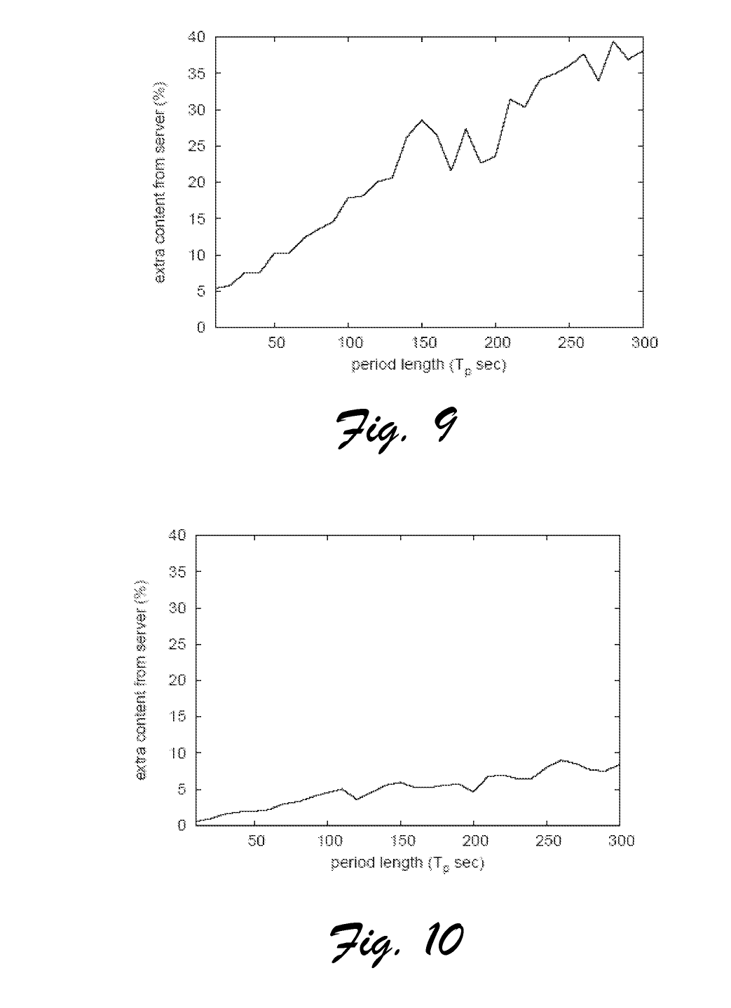

FIG. 10 shows a comparison between an optimal policy and a simulation of hybrid streaming according to another approach of filling up a playback buffer.

### DETAILED DESCRIPTION

This disclosure is directed to techniques for streaming media over a network, such as the Internet. More particularly, the techniques involve a hybrid approach of retrieving media from more than one source—peer-to-peer, streaming media servers, web servers, etc.—depending upon various factors.

The source(s) from which media is retrieved during a streaming session are selected based on factors such as a status of a playback buffer from which the media is played back, compliance with an optimization policy, and so forth. The optimization policy may further be defined in various ways, such as maintaining a given Quality of Service (QoS) at minimum cost of service, minimizing an amount of streaming media content retrieved from a SM server at a given QoS, or the like. In an exemplary implementation, hybrid streaming may be realized by contacting and retrieving the media from one or more sources in order to comply with a given optimization policy or a desired status of the playback buffer.

Multiple and varied implementations and embodiments are described below. In the following section, an exemplary environment that is suitable for practicing various implementations is discussed. After this discussion, representative implementations of systems, devices, and processes for implementing the hybrid streaming techniques are described.

Exemplary Environment

FIG. 1 shows an exemplary environment 100 that is suitable for implementing hybrid peer-to-peer streaming with server assistance. For discussion purposes, environment 100 includes at least one computing device 102 linked to one or more streaming media (SM) servers 104 and one or more Peer-to-Peer (P2P) networks 106 through a network 108. The computing device 102 may further have access to one or more web servers, such as web server 110, through the network 108.

The computing device 102 may be implemented as any of a variety of conventional computing devices, including, for example, a server, a desktop PC, a notebook or portable computer, a workstation, a mainframe computer, a mobile computing device, an entertainment device, a game console, a set-top box, a DVD player, an Internet appliance, etc. that are configurable to receive streaming media content.

The network 108 may be a wireless or a wired network, or a combination thereof. The network 108 can be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs). Further, the individual networks may be wireless or wired networks, or a combination thereof.

In one configuration, the computing device 102 includes a streaming control module 112 to implement hybrid streaming. The term “streaming” is used to indicate that data (streaming media content) is provided over the network 108 to the computing device 102 and that playback of the content can begin prior to the data being delivered in its entirety. The term “hybrid streaming” is used to indicate that the computing device 102 may receive various parts of a streaming file from one or more media sources, such as a SM server 104, a P2P network 106, and a web server 110. The streaming control module 112 coordinates the hybrid streaming by selecting the one or more media sources from which streaming media content is to be retrieved.

In one implementation, during a streaming session, the computing device 102 receives streaming media content over the network 108 from one or more media sources such as a SM server 104, a P2P network 106 and a web server 110. The streaming session is divided into time units and the media source(s) from which the streaming media content (data) is retrieved at a time unit is selected by the streaming control module 112. The streaming control module 112 may select one or more media source(s) for data retrieval at every time unit, at pre-decided time units, or at random time units. The time units may be measured in different ways, including in temporal fashion (i.e. every second of media) or as a specified number of frames (e.g., every frame or every N frames). The streaming control module 112 determines whether the streaming media content received at respective time units is less than a threshold or target amount. The determination may be made, for example, by monitoring an amount of data available for playback at a time unit. Based on this determination, the streaming control module 112 selects an appropriate source (e.g., SM server 104, P2P network 106, web server 110) to retrieve the streaming media content for a respective time unit.

As a more specific example, the streaming control module 112 may make source decisions in an effort to ensure QoS while exploiting the resources of the P2P network. Thus, the streaming control module 112 may initially retrieve streaming data from the P2P network 106. In the event that the throughput from the P2P network 106 is not sufficient for continuous playback, the streaming control module 112 retrieves data from the SM server 104. The SM server 104 is capable of streaming at a fixed bit rate or a variable bit rate.

Further, the streaming control module 112 may select the media source(s) based on an optimization policy, such as maintaining a given Quality of Service (QoS) at minimum cost of service, minimizing an amount of streaming media content retrieved from a SM server at a given QoS, or other like policies. Exemplary working of the streaming control module 112 is described in detail with reference to FIG. 2.

FIG. 2 illustrates various components of an exemplary computing device 102 suitable for implementing hybrid streaming in more detail. The computing device 102 can include, but is not limited to, a processor 202, a memory 204, Input/Output (I/O) devices 206 (e.g., keyboard and mouse), and a system bus 208 that operatively couples various components including processor 202 to memory 204.

System bus 208 represents any of the several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394 (i.e., FireWire) bus.

Memory 204 includes computer-readable media in the form of volatile memory, such as Random Access Memory (RAM) and/or non-volatile memory, such as Read Only Memory (ROM) or flash RAM. Memory 204 typically includes data and/or program modules for implementing hybrid streaming that are immediately accessible to and/or presently operated on by processor 202. In one embodiment, the memory 204 includes a streaming control module 112, a network interface 210, a first buffer 212, a second buffer 214, a third or playback buffer 216, and other applications 218. The first and second buffers 212 and 214 store media (streaming media content) streamed from different sources 1 and 2, respectively. In other implementations, the memory 204 may have additional buffers corresponding to additional media sources in the event that streaming media is received from more than two sources during a streaming session. Thus, the memory 204 may further have buffer 3, buffer 4, buffer 5, and so on for corresponding media source 3, media source 4, media source 5, and so forth. The third or playback buffer 216 stores the media in a form suitable for playback. For example, the media received from two or more media source(s) or buffers may be combined or merged and stored in the playback buffer 216 as a continuous block of data available for playback.

Though FIG. 2 shows the streaming control module 112 as residing on the computing device 102, it will be understood that the streaming control module 112 need not be hosted on the computing device 102. For example, the streaming control module 112 could also be hosted on a storage medium communicatively coupled to the computing device 102. This includes the possibility of the streaming control module 112 being hosted in whole, or in part, on the computing device 102. Moreover, the media received during the streaming session may be played back on the computing device 102, or on another device, such as a TV. In this manner, the streaming control module 112 may reside on the same device used to play back the media or on a separate device from the play back device.

The network interface 210 may enable the computing device 102 to send and receive commands and media content from the media sources linked to the network 108. For example, the network interface 210 may be used by the computing device 102 to receive streaming media content from one or more of the SM server 104, the P2P network 106 and the web server 110 over the network 108.

In one implementation, during a streaming session divided into time units, the streaming control module 112 makes a decision at a time unit as to which media source(s) to contact and receive data from for the duration of at least that time unit. The decision may be based on an optimization policy, such as maintaining a given Quality of Service (QoS) at minimum cost of service or minimizing an amount of streaming media content retrieved from a SM server at a given QoS.

For example, to minimize the amount of streaming media content retrieved from the SM server 104 at a given QoS, the streaming control module 112 monitors an amount of streaming media content in the playback buffer 216. If the amount of streaming media content in the playback buffer at a time unit is less than a target amount, the streaming control module retrieves data for the time unit from a SM server 104. On the other hand, if the amount of streaming media content in the playback buffer at a time unit is more than the target amount, the streaming control module retrieves data for the time unit from a P2P network 106. The target amount may be determined based on one or more of a playback rate from the playback buffer, or on the optimization policy, etc.

In one implementation, the playback buffer 216 may receive streaming media content directly from selected media source(s) such as a SM server 104, a P2P network 106, or a web server 110. In another implementation, the playback buffer 216 may receive streaming media content from one or more of the first buffer 212 and the second buffer 214, which in turn receive streaming media content from respective media sources, i.e., media source 1 and media source 2. Media source 1 and media source 2 may be one or more of the SM server 104, P2P network 106, or web server 110. The playback buffer 216 may further receive data from additional buffers corresponding to additional media sources such as media source 3, media source 4, and so forth.

Generally, program modules executed on the components of computing device 102 include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

An implementation of these modules and techniques may be stored on or transmitted across some form of computer-readable media. Computer-readable media can be any available media that can be accessed by a computer. By way of example, and not limitation, computer-readable media may comprise computer storage media that includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium, which can be used to store the desired information and which can be accessed by a computer.

Exemplary Data Flow in Hybrid Streaming

In one exemplary implementation of hybrid streaming, the streaming control module 112 selects one or more media source(s) from which to retrieve data during a streaming session. The data retrieved from the selected media source(s) may be directly received by the playback buffer 216 or by one or more of the first buffer 212, the second buffer 214, and so forth. Where intermediate buffers are used, the first buffer 212, the second buffer 214, and so forth in turn send the data to the playback buffer 216.

FIG. 3 illustrates an exemplary scenario in which the playback buffer 216 receives data from a first buffer 212 and a second buffer 214. For illustration purposes, the first buffer 212 and the second buffer 214 are shown to receive data from at least one P2P network 106 and at least one SM server 104 respectively. It will be understood, however, that the first buffer 212 and the second buffer 214 may receive data from any of the SM server 104, the P2P network 106, or the web server 110.

In one implementation, the streaming control module 112 coordinates flow of data from the first buffer 212 and the second buffer 214 to the playback buffer 216 in accordance with an optimization policy. As an example optimization policy, the streaming control module 112 may employ a tiered approach in which two threshold values, i.e. a lower bound and an upper bound, are employed in determining from which source to retrieve the media. The streaming control module 112 assigns a high priority to one of the first buffer 212 or the second buffer 214 at a time unit based on the amount of data in the playback buffer 216 at that time unit. In one scenario, when the amount of data in the playback buffer 216 is below the lower bound, both the first buffer 212 and the second buffer 214 send data to the playback buffer 216. When the amount of data in the playback buffer 216 is between the lower bound and the upper bound, the high priority buffer sends data to the playback buffer 216. Then, when the amount of data in the playback buffer 216 is above the upper bound, neither buffer sends data to the playback buffer 216.

Further, the streaming control module 112 may also regulate throughputs of the first buffer 212 and the second buffer 214, thereby regulating an amount of data retrieved from the selected media source(s). For example, when rate of consumption of data (playback) from the playback buffer 216 slows down, there is less empty space in the playback buffer 216. Therefore, the rate of incoming data to the playback buffer 216 may be reduced by throttling back the throughputs of the first buffer 212 and the second buffer 214. Additionally, when the throughputs of the first buffer 212 and the second buffer 214 are throttled, the rate of incoming data from the P2P network 106 and the SM server 104 may also be throttled. Thus, the streaming control module 112 may also regulate the throughputs of the P2P network 106 and the SM server 104 when streaming data to the computing device 102.

In FIG. 3, the regulation of an amount of data in the playback buffer 216 and throughputs of the P2P network 106 and the SM server 104 have been described in the context of using intermediate buffers 212 and 214. However, it will be understood that the amount of data in the playback buffer 216 and throughputs of the P2P network 106 and the SM server 104 can be regulated in a similar manner even in a case where the playback buffer 216 receives data directly from the P2P network 106 and the SM server 104 or from other selected media source(s), rather than via intermediate buffers 212 and 214.

As noted above, the streaming control module 112 may make the decision as to which media source(s) to select and receive data from based on an optimization policy. As one example, suppose the optimization policy is denoted by A, which is the complete set of all decisions (actions) over the entire streaming session, such that A={a(k)|0≦k<N}, where k is a time unit at which a decision a(k) is taken and N is a total number of time units in the entire streaming session (where each unit corresponds to a second, frame, etc.). For example, a scenario where the streaming control module 112 requests data from the SM server 104 may be represented as a(k)=1, while a(k)=0 may represent a scenario where the streaming control module 112 requests data from the P2P network 106. In such a case, the total data requested from the SM server 104 may be computed as:

$$W = {\sum }_{k = 0}^{N - 1} a ( k ) {r}_{w} ( k ) \qquad ( 1 )$$

where r_{w}(k) is throughput from the SM server 104.

In an exemplary implementation of hybrid streaming, the streaming media content (data) may be received from either the P2P network 106 or the SM server 104 or both based on minimizing an amount of streaming media content retrieved from the SM server 104 at a given quality of service (QoS). In this exemplary implementation, an optimization policy A* corresponds to minimizing load on the SM server 104 during a streaming session while maintaining the given QoS. At the beginning of a time unit k(0≦k<N), the streaming control module 112 takes a decision whether to contact and request data from the P2P network 106 or the SM server 104 or both. The streaming control module 112 may take this decision at every time unit or at pre-decided time units or at random time units during the streaming session.

In one case, the streaming control module 112 may retrieve data from the P2P network 106 alone and thus, there is no load on the SM server 104. In such a case, throughput rₚ(k) of the P2P network 106 might be less than a media bit rate rₘ and result in the playback buffer 216 shrinking, or the throughput rₚ(k) might be enough to sustain the given QoS.

Alternatively, the streaming control module 112 may retrieve data from either or both of the P2P network 106 and the SM server 104. In this case, let throughput from the SM server 104 be denoted by r_{w}(k) and throughput from the P2P network 106 be denoted by r′ₚ(k). Total incoming throughput r_{w}(k)+r′ₚ(k) is capped by download link capacity r_{c} of the computing device and is enough to sustain the given QoS. Let a(k) denote the decision (action) that the streaming control module 112 takes at a time unit k. A scenario where the streaming control module 112 requests data from the SM server 104 may be represented as a(k)=1, while a scenario where the streaming control module 112 requests data from the P2P network 106 may be represented as a(k)=0. A status of the playback buffer at time k may be denoted as t_{b}(k). Then, the state transition or status of the playback buffer at time (k+1) can be summarized as:

$${t}_{b} ( k + 1 ) = \{ \begin{matrix} {t}_{b} ( k ) + \frac{{r}_{w} ( k ) + {r}_{p}^{′} ( k )}{{r}_{m}} - 1 , & a ( k ) = 1 \\ {t}_{b} ( k ) + \frac{{r}_{p} ( k )}{{r}_{m}} - 1 , & a ( k ) = 0\end{matrix} \qquad ( 2 )$$

To comply with optimization policy A*, the total amount of data retrieved from the SM server 104, computed as

$$W = {\sum }_{k = 0}^{N - 1} a ( k ) {r}_{w} ( k ) ,$$

is to be minimized. Further, to maintain the given QoS, the playback buffer 216 may not be allowed to underflow, i.e. t_{b}(k)≧0 for all k's. Also, the playback buffer 216 may have an upper bound T_{b}, which confines t_{b}(k)≦T_{b} for all k's. Therefore, the optimization policy A*={a*(k) 0≦k<N} may be defined by:

$$min W = {\sum }_{k = 0}^{N - 1} a ( k ) {r}_{w} \\ such that 0 \leq {t}_{b} ( k ) \leq {T}_{b} ( 0 \leq k < N ) \qquad ( 3 )$$

To comply with optimization policy A*, data is retrieved from either or both of the SM server 104 and the P2P network 106. There are multiple ways to fill the playback buffer according to the optimization policy. Two possible scenarios are described below with reference to FIGS. 4 and 5.

FIG. 4 illustrates a first scenario 400 to filling up the playback buffer 216 with streaming media from different sources according to an optimization policy. In this scenario, the buffer is filled in the same temporal direction in a streaming session. As shown in FIG. 4, the streaming session may be divided into multiple time units (periods) Tₚ. During a period if throughput from P2P network is not sufficient to sustain a threshold (target) amount of data t_{d} in the playback buffer 216, the streaming control module 112 streams a continuous fraction of data directly from the SM server 104 and then acquires the rest of the data from the P2P network 106. Given the period length Tₚ, a minimum amount of content to be streamed from the SM server 104, denoted by t_{w}, may be computed, as described below.

At the beginning of a period, the playback buffer 216 may already have t_{d} worth of content (in terms of media time). As shown in FIG. 4, the period may be divided into three stages at times t=t_{d} and t=t_{d}+t_{w} and t=Tₚ. Also, the third stage (t_{d}+t_{w})≦t<Tₚ may be further sub-divided into three periods denoted by t_{I}, t_{II} and t_{III}. Data may be retrieved during the durations t_{I}, t_{II} and t_{III} with or without any parallel processing such as playing back data from other parts of the playback buffer 216 or receiving data in other portions of the playback buffer 216.

In the first stage (0≦t<t_{d}), the computing device 102 consumes data from the playback buffer 216 and requests data from the P2P network in the meanwhile. An amount of data t_{I} obtained from the P2P network 106 in this stage may therefore be computed to be:

$${t}_{I} = {t}_{d} \frac{{r}_{p}}{{r}_{m}} \qquad ( 4 )$$

where rₚ denotes throughput from the P2P network and rₘ denotes media bit rate.

During the second stage (t_{d}≦t≦t_{d}+t_{w}) the streaming control module 112 streams and plays back data directly from the SM server 104. In case residual bandwidth is available, the streaming control module 112 also acquires data from the P2P network 106. The throughput of the P2P network 106 would then be capped by the link capacity (r_{c}) and would change to r′ₚ, where r′ₚ=min(r_{c}−rₘ,rₚ). The data retrieved from the P2P network 106 in this stage, t_{II}, may therefore be computed as shown below:

$${t}_{II} = {t}_{w} \frac{{r}_{p}^{′}}{{r}_{m}} \qquad ( 5 )$$

The third stage begins at t=t_{d}+t_{w}, when the streaming control module 112 stops streaming from the SM server 104 and starts playing out buffered data. The playback buffer 216 would have data sufficient for playback for duration equal to t_{I}+t_{II} at the beginning of this stage. The streaming control module 112 continues to acquire data from the P2P network 106 while consuming data from the playback buffer 216. An additional time in the third stage for which the streaming control module 112 would continue to acquire data from the P2P network 106 is denoted by t_{III}. The throughput from the P2P network 106 would resume to rₚ, as streaming from the SM server 104 would have stopped. The third period t_{III} of the third stage may therefore be computed by:

$$( {t}_{I} + {t}_{II} + {t}_{III} ) \frac{{r}_{p}}{{r}_{m}} - {t}_{III} \geq {t}_{d}^{′} \qquad ( 6 )$$

Further, as shown in FIG. 3, the time period Tₚ may be given by:

t_{d}+t_{w}+t_{I}+t_{II}=t_{III}=Tₚ (7)

Solving Eq. (4)-(7), minimum amount of content to be streamed from the SM server 104, or t_{w}, can be computed to be:

t_{w}(rₘ−rₚ+rₚ)≧Tₚ(rₘ−rₚ)+(t_{d}−t_{d})rₘ (8)

Therefore, the minimum amount of streaming media content to be streamed from the SM server 104 (denoted by t_{w}) and a point in the streaming media content (t_{d}+t_{w}) at which the streaming control module 112 stops acquiring data from the SM server 104 and starts acquiring data from the P2P network 106 may be computed.

FIG. 5 shows a second scenario 500 for complying with the optimization policy A* (i.e., minimizing the load on the SM server 104 during a streaming session while maintaining the given QoS). Here, data is retrieved from either or both of the SM server 104 and the P2P network 106, but the data fills out the media stream held in the playback buffer 216 from opposite time directions. As shown in FIG. 5, the streaming session may be divided into multiple time units (periods) Tₚ. During a period, if throughput from P2P network is not enough to sustain a threshold (target) amount of data t_{d} in the playback buffer, the streaming control module 112 streams a continuous fraction of data directly from the SM server 104 and acquires rest of the data from the P2P network 106.

At the beginning of a period, the playback buffer 216 may already have td worth of content. So an amount of data that can be retrieved while playing through this buffer may be computed as:

T_{d}=t_{d}(rₚ+r_{w})/rₘ (9)

where rₚ, r_{w} and rₘ are throughput of the P2P network 106, throughput of the SM server 104, and media bit rate. Let T′ₚ be the smaller value between Td and the period length Tₚ, so that T′ₚ can be represented as T′ₚ=min(T_{d},Tₚ). The streaming control module 112 starts downloading simultaneously from the SM server 104 and the P2P network 106 in opposite directions from time position t_{d} and t_{d}+T′ₚ, respectively, as shown in FIG. 5. Since rₚ+r_{w}>rₘ, the data that is retrieved from the SM server 104 and the data that is retrieved from the P2P network 106 meets in time less than t_{d}. Then, the streaming control module 112 stops acquiring data from the SM server 104. Further, if T′ₚ<Tₚ, the streaming control module 112 continues to request data from the P2P network 106 after time position t_{d}+T′ₚ in time sequential direction. After td, the streaming control module 112 consumes the new buffer built in this period, while continuing to request data from the P2P network 106.

Though FIG. 4 and FIG. 5 have been described with reference to hybrid streaming from a P2P network and a SM server in accordance with an optimization policy A*, it will be understood that similar computations and methods may be used to implement hybrid streaming from any selection of media source(s) in compliance with any optimization policy Â.

There can be situations during streaming when there is no data in the playback buffer 216. In such a scenario, the playback buffer 216 may be grown to a stage so that there is at least a threshold amount of data in the playback buffer 216. Then, the data in the playback buffer 216 can sustain for a period of playback during which, the streaming control module 112 can retrieve further data. Such situations can occur at start-up, or when a user seeks to play from a new position, or if a new media file is pre-loaded before the end of an old one, or when a user starts a video file without following a playlist, etc.

In one implementation, to grow the data in the playback buffer 216 from no data to a threshold amount, an initial delay of reasonable time may be given during which the streaming control module 112 retrieves data from at least one of the media sources. The media source(s) may be selected by the streaming control module 112 based on throughputs of the media sources and on the optimization policy. In an exemplary implementation of hybrid streaming, the media source(s) may be selected from either the P2P network 110 or the SM server 104 or both based on minimizing an amount of streaming media content retrieved from the SM server 104 at a given quality of service (QoS). In such a case, as an initial delay is acceptable, data retrieval from the P2P network 106 may be given a greater priority. Thus, if the throughput of the P2P network 106 is sufficient to grow the playback buffer 216, the streaming control module 112 may retrieve data only from the P2P network 106. On the other hand, if the throughput of the P2P network 106 is not sufficient to grow the playback buffer 216, the streaming control module 112 may retrieve data from at least the SM server 104, with or without simultaneous data retrieval from the P2P network 106. Further, if the streaming control module 112 retrieves data from both the SM server 104 and the P2P network 106, the retrieval may be in a same time direction as explained earlier with reference to FIG. 4, or in different time directions as explained earlier with reference to FIG. 5.

In another implementation, to grow the data in the playback buffer 216 from no data to a threshold amount, it may not be desirable to have an initial delay. In such a case, data retrieval from the SM server 104 may be given a greater priority. The streaming control module 112 may retrieve data simultaneously from the P2P network 106 also based on residual bandwidth available. Further, if the streaming control module 112 retrieves data from both the SM server 104 and the P2P network 106, the retrieval may be in a same time direction as explained earlier with reference to FIG. 4, or in different time directions as explained earlier with reference to FIG. 5.

Exemplary Processes

FIG. 6 illustrates an exemplary process 600 for implementing hybrid streaming. The process 600 (as well as other processes described below) is illustrated as a collection of blocks in a logical flow graph, which represents a sequence of operations that can be implemented in hardware, software, or a combination thereof. In the context of software, the blocks represent computer instructions that, when executed by one or more processors, perform the recited operations. For discussion purposes, the process 600 (as well as other processes described below) is described with reference to environment 100 shown in FIG. 1 and computing device 102 shown in FIG. 2. In an exemplary implementation of process 600 (as well as other processes described below), the hybrid streaming is implemented to conform to an optimization policy A* that corresponds to minimizing load on the SM server 104 during a streaming session while maintaining a given QoS. It will be apparent to a person ordinarily skilled in the art that environment 100, computing device 102 and optimization policy A* are described for exemplary purposes and the process 600 (as well as other processes described below) may be implemented in other environments, systems or network architectures to comply with other optimization policies.

The process 600 monitors a status of the playback buffer 216 and selects one or more media source(s) from which to retrieve data during a streaming session. The streaming session is preferably divided into many time units. At block 602, the streaming control module 112 determines whether an amount of data in the playback buffer 216 is less than a threshold amount. The threshold amount may be determined based, for example, on a playback rate from the playback buffer, an optimization policy, or other factors. The optimization policy may be defined in various ways, such as maintaining a given Quality of Service (QoS) at minimum cost of service, or minimizing an amount of streaming media content retrieved from a SM server at a given QoS, or so forth.

If the amount of data in the playback buffer 216 is determined to be less than the threshold amount (i.e. the “yes” branch from block 602), data is retrieved from the SM server 104 for at least one time unit (block 604). Additionally, data may also be retrieved simultaneously from the P2P network 106 if residual bandwidth is available. Alternatively, if the amount of data in the playback buffer 216 is determined to be more than the threshold amount (i.e. the “no” branch from block 602), data for at least the time unit is retrieved from at least one P2P network 106 (block 606).

In cases where the streaming control module 112 retrieves data simultaneously from both the SM server 104 and the P2P network 106, the streaming control module 112 may retrieve the data and fill the playback buffer 216 with data arranged in the same time direction or in opposite time directions. A scenario in which data is retrieved in a same time direction is described below with reference to FIG. 7. Another scenario in which data is retrieved in opposite time directions is described later with reference to FIG. 8.

At block 608, the retrieved data is received in the playback buffer 216. At block 610, data in the playback buffer 216 is played back. While the data is played back from the playback buffer 216, data is also simultaneously received in the playback buffer from at least one of the SM server 104 and the P2P network 106. To select which media source(s) to retrieve data from, actions illustrated as blocks 602 to 608 are repeated. The operation may be repeated at every time unit, at pre-decided time units, or at random time units.

FIG. 7 illustrates a process 700 for retrieving data from one or more of the SM server 104 and the P2P network 106 and filling the playback buffer 216 in a same time direction. For discussion purposes, this process 700 will be described with additional reference to elements of FIG. 4. At block 702, the streaming control module 112 determines whether an amount of data in the playback buffer 216 is less than a threshold amount t_{d}. The threshold amount t_{d} may be determined based on a playback rate from the playback buffer, an optimization policy, and/or other factors or considerations. The optimization policy may be defined in various ways. Possible policies might be maintaining a given Quality of Service (QoS) at minimum cost of service or minimizing an amount of streaming media content retrieved from a SM server at a given QoS.

If the amount of data in the playback buffer 216 is more than the threshold amount (i.e. the “no” branch from block 702), data is retrieved from at least one P2P network 106 for at least one time unit (block 704). Alternatively, if the amount of data is less than the threshold amount (i.e. the “yes” branch from block 702), a computation is made to determine an amount of data, in terms of media time and denoted t_{w}, to be retrieved from the SM server 104 (block 704). One exemplary computation to find the amount of data t_{w} can be made using equation (8) above, as explained earlier with reference to FIG. 4.

At block 708, retrieval of data t_{w} from the SM server 104 is started. At block 710, the streaming control module 112 determines whether residual bandwidth is available. At block 712, if residual bandwidth is not available (i.e. the “no” branch from block 710), retrieval of data t_{w} from the SM server 104 continues until finished. Alternatively, at block 714, assuming residual bandwidth is available (i.e. the “yes” branch from block 710), data is retrieved simultaneously from the P2P network 106 while retrieval of data t_{w} from the SM server 104 is finished. The data retrieval from the P2P network 106 at block 714 is started from a point (t_{d}+t_{w}) in the streaming media content. At block 716, data reverts to being retrieved from the P2P network 106.

At block 718, the retrieved data is received in the playback buffer 216. At block 720, data in the playback buffer 216 is played back. While the data is played back from the playback buffer 216, data is also simultaneously received in the playback buffer from at least one of the SM server 104 and the P2P network 106. To select which media source(s) to retrieve data from, actions illustrated as blocks 702 to 718 are repeated. The operation may be repeated at every time unit, at pre-decided time units, or at random time units.

FIG. 8 illustrates a process 800 for retrieving data from one or more of the SM server 104 and the P2P network 106 and filling the playback buffer 216 from different time direction. For discussion purposes, this process 800 will be described with additional reference to elements of FIG. 5. At block 802, the streaming control module 112 determines whether an amount of data in the playback buffer 216 is less than a threshold amount t_{d}. If the amount of data in the playback buffer 216 is determined to be more than the threshold amount (i.e. the “no” branch from block 802), data is retrieved from at least one P2P network 106 for at least one time unit (block 804). Alternatively, if the amount of data in the playback buffer 216 is determined to be less than the threshold amount (i.e. the “yes” branch from block 802), data is retrieved simultaneously from the SM server 104 and the P2P network 106 and used to fill the playback buffer in opposite time directions. For example, with reference to FIG. 5, data is retrieved from the SM server 104 in forward direction from a point t_{d} in the streaming media content, and from the P2P network 106 in backward direction from end of the time unit. In this case, the amount of data t_{w} retrieved from the SM server may not be pre-computed. Instead, retrieval from the SM server is stopped when data from the two retrievals (i.e. from the SM server 104 and the P2P network 106) meet.

At block 810, the retrieved data is received in the playback buffer 216. At block 812, data in the playback buffer 216 is played back. While the data is played back from the playback buffer 216, data is also simultaneously received in the playback buffer from at least one of the SM server 104 and the P2P network 106. To select which media source(s) to retrieve data from, the actions illustrated as blocks 802 to 810 are repeated. The operation may be repeated at every time unit, at pre-decided time units, or at random time units.

Exemplary Simulation Results

FIG. 9 shows a performance comparison between a simulation for process described in FIG. 7 and an optimal policy A* under various choices of period length Tₚ. Every point is an average of 10 samples. In the simulation, the media bit rate is set to 1 Mbps and incoming link capacity is set to 1.5 Mbps. Throughput of the P2P network 106 is set to vary between 250 Kbps and the link capacity. After each variation, the P2P network 106 stays constant for an amount of time. The amount of time follows an exponential distribution with a mean value of 10 seconds. Maximum playback buffer is set to 300 seconds.

FIG. 10 shows a performance comparison between a simulation for process described in FIG. 8 and an optimal policy A* under various choices of period length Tₚ under similar conditions as used for the simulation results shown in FIG. 9.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
determining whether streaming media content received at respective time units is less than a target amount; and
selecting from among at least one streaming media server and at least one peer to peer network to retrieve the streaming media content for a respective time unit based on the determination.

2. A method as recited in claim 1, wherein the streaming media content is retrieved from at least one streaming media server in response to a determination that the streaming content received is less than the target amount.

3. A method as recited in claim 1, wherein the streaming media content is retrieved from at least one peer to peer network in response to a determination that the streaming content received is not less than the target amount.

4. A method as recited in claim 1, wherein the streaming media content is retrieved simultaneously from at least one peer to peer network and at least one streaming media server.

5. A method as recited in claim 4, wherein the streaming media content is retrieved in a same time direction from the streaming media server and the peer to peer network.

6. A method as recited in claim 4, wherein the streaming media content is retrieved in different time directions from the streaming media server and the peer to peer network.

7. A method as recited in claim 1, further comprising:
receiving a first portion of the streaming media content retrieved from at least one peer to peer network into a first buffer;
receiving a second portion of the streaming media content retrieved from at least one streaming media server into a second buffer; and
merging the first and second portions of the streaming media content from the first and second buffers, respectively, into a third buffer.

8. A method as recited in claim 7, further comprising pausing said merging when the streaming media content in the third buffer is more than a threshold amount.

9. A method as recited in claim 1, wherein the selecting is further based on minimization of streaming media content retrieved from the streaming media server for a given quality of service.

10. A computing-based device comprising:
a memory;
one or more processors operatively coupled to the memory; and
a streaming control module configured to coordinate retrieval of streaming media content from a plurality of media sources based on a pre-determined optimization policy and on a status of a playback buffer, wherein the plurality of media sources includes at least one streaming media server and at least one peer to peer network.

11. A computing-based device as recited in claim 10, wherein the plurality of media sources further includes a web server.

12. A computing-based device as recited in claim 10, wherein:
the streaming media content is retrieved from at least one peer to peer network when the streaming media content in the playback buffer is more than a threshold amount; and
the streaming media content is retrieved from at least one streaming media server when the streaming media content in the playback buffer is less than a threshold amount.

13. A computing-based device as recited in claim 10, wherein the pre-determined optimization policy includes minimization of cost of service for a given quality of service.

14. A computing-based device as recited in claim 10, wherein the pre-determined optimization policy includes minimization of streaming media content retrieved from the streaming media server for a given quality of service.

15. A computing-based device as recited in claim 10, wherein the streaming control module regulates throughput from the plurality of media sources.

16. A computer-readable medium having a set of computer readable instructions that, when executed, perform acts comprising:
evaluating whether an amount of streaming media content in a playback buffer is less than a threshold value at a time unit in a streaming session; and
retrieving streaming media content for at least the time unit from at least one peer to peer network if the amount of streaming media content in the playback buffer is not less than the threshold value and from at least one streaming media server if the amount of streaming media content in the playback buffer is less than the threshold value.

17. A computer-readable medium as recited in claim 16, wherein the streaming media content is retrieved simultaneously from at least one streaming media server and at least one peer to peer network.

18. A computer-readable medium as recited in claim 16, wherein the retrieving is further based on minimization of streaming media content retrieved from the streaming media server for a given quality of service.

19. A computer-readable medium as recited in claim 16, wherein
a first portion of the streaming media content is retrieved from at least one peer to peer network is received in a first buffer;
a second portion of the streaming media content is retrieved from at least one streaming media server is received in a second buffer; and
the first portion and the second portion of the streaming media content from the first and second buffers are merged into the playback buffer.

20. A computer-readable medium as recited in claim 19, wherein:
the merger is paused when the streaming media content in the playback buffer is more than a first threshold amount; and
the merger is resumed when the streaming media content in the playback buffer is less than a second threshold amount, wherein the first and second threshold amounts are one of (1) a same amount or (2) different amounts.
